(19) United States
(12) Patent Application Publication
(10) Pub. No.: US 2013/0030334 A1
(43) Pub. Date: Jan. 31, 2013

(54) VIBRATING PULL UP BAR

(71) Applicant: Scott C. Agostini, San Juan Capistrano, CA (US)

(72) Inventor: Scott C. Agostini, San Juan Capistrano, CA (US)

(21) Appl. No.: 13/556,779

(22) Filed: Jul. 24, 2012

Related U.S. Application Data
(60) Provisional application No. 61/512,540, filed on Jul. 28, 2011.

(51) Int. Cl. A61H 1/00; A63B 1/00

(52) U.S. Cl. 601/46; 482/40

(57) ABSTRACT

Provided is a vibrating pull-up bar configured to allow a user to perform a conventional pull-up, while at the same time imparting a vibratory force to the individual which resonates throughout the individual's body to exercise muscle groups at various locations of the user's body.

### CROSS-REFERENCE TO RELATED APPLICATIONS

This application claims the benefit of U.S. Provisional Application No. 61/512,540, filed Jul. 28, 2011.

### STATEMENT RE: FEDERALLY SPONSORED RESEARCH/DEVELOPMENT

Not Applicable

### BACKGROUND OF THE INVENTION

1. Technical Field of the Invention

The present invention relates generally to an exercise device, and more specifically to a vibrating pull up bar which provides a highly effective workout by imparting a vibratory force on the user, which in turn, exercises various muscle groups throughout the user's body.

2. Description of the Related Art

Routine exercise and physical therapy, such as aerobic conditioning, strength training, and rehabilitation are widely recognized as providing benefits to an individual's health and well being. Furthermore, exercises such as walking, running, weight lifting, bicycling, swimming, and rowing, to name a few, are known to provide health benefits.

Exercise products have been developed to mimic training for everyday activities. Along these lines, many exercise machines focus on a single muscle group or a single plane of motion, thereby limiting the workout experienced by the user. The human body is designed to move in multiple planes of motion at different speeds that should be safely trained to prepare the body for everyday challenges. With a lack of time to exercise, many people turn to different types of exercise equipment with the hope of getting fast results.

Modern science has also shown that movement based exercise training may lead to better results because it challenges the body to perform at different speeds and follow different movement patterns that involve different muscle groups. For instance, movement involving multiple joints moving at multiple speeds in different directions may promote body stability, balance, realignment and coordination. Strength training with additional vibration has been shown to augment strength and power over and above that achieved with strength training along. This effect is achieved through stimulation of additional muscle fibers above the normal stimulation level.

To that end, the use of vibration has recently been implemented into exercise and strength training to provide a more comprehensive workout to the individual. For instance, several exercise devices have been developed which target a particular muscle group with vibratory stimulation. Several upper body training devices have been designed to incorporate vibratory technology. Exemplary devices include dumbbell-type devices that include a vibrating device integrated therein, or a device that is held by the user and is shaken by the user to impart a vibratory effect on the user.

Although such vibrating exercise devices provide a more effective workout relative to conventional exercise equipment that is designed to target similar muscle groups, the muscle-targeting vibrating exercise devices are typically not designed to exercise muscle groups throughout the body.

In view of the foregoing, there is a need in the art for an exercise apparatus which is designed to impart vibration impulses to a user's body to exercise muscle groups throughout the user's body.

### BRIEF SUMMARY OF THE INVENTION

The present invention specifically addresses and alleviates the above-identified deficiencies in the art. There is provided a vibrating pull-up bar configured to allow a user to perform a conventional pull-up, while at the same time imparting a vibratory force to the individual which resonates throughout the individual's body to exercise muscle groups at various locations of the user's body. In this regard, the vibrating pull-up bar provides a more effective workout to the user relative to conventional pull-up bars.

According to one embodiment, the vibrating pull-up bar includes an elongate body defining a first end portion and an opposing second end portion, and a middle portion disposed between the first end portion and the second end portion. The elongate body defines a tubular configuration including an inner compartment which houses a vibrating element and an internal power source in operative communication with the vibrating element. The vibrating element is configured to vibrate the pull-up bar as the user hangs from the pull-up bar and performs a pull-up, thereby sending vibratory pulses throughout the user's body to provide a more comprehensive, full-body workout to the user.

The vibrating pull-up bar may additionally include a pair of adjustable engagement elements connected to the bar body. The engagement elements may be adjusted relative to the bar body to fit the vibrating pull-up bar within a door frame, parallel wall structure, or other base structure to which the vibrating pull-up bar may be disposed.

The vibrating pull-up bar may include a control switch for turning the vibrating element ON or OFF. The vibrating element may have multiple operation modes, which may correspond to varying vibration frequencies and magnitudes. The switch may allow the user to easily transition between the various operational modes.

The present invention is best understood by reference to the following detailed description when read in conjunction with the accompanying drawings.

### BRIEF DESCRIPTION OF THE DRAWINGS

These as well as other features of the present invention will become more apparent upon reference to the drawings wherein:

FIG. 1 is a front view of a vibrating pull-up/exercise bar connected to a door frame with a user gripping the pull-up bar and hanging therefrom;

FIG. 2 is a front view of the pull-up bar, with a portion of the bar shown as a section view to depict an internal power source and vibrating element;

FIG. 3 is a front view of one embodiment of the pull-up bar having multi-directional vibrating capabilities; and

FIG. 4 is a top sectional view of an end of the pull-up bar having an engagement channel for engaging with a door frame.

Common reference numerals are used throughout the drawings and detailed description to indicate like elements.

### DETAILED DESCRIPTION OF THE INVENTION

The detailed description set forth below is intended as a description of the presently preferred embodiment of the invention, and is not intended to represent the only form in which the present invention may be constructed or utilized. The description sets forth the functions and sequences of steps for constructing and operating the invention. It is to be understood, however, that the same or equivalent functions and sequences may be accomplished by different embodiments and that they are also intended to be encompassed within the scope of the invention.

Referring now to the drawings, wherein the showings are for purposes of illustrating a preferred embodiment of the present invention only, and not for purposes of limiting the same, there is shown a vibrating pull-up bar 10 constructed in accordance with an embodiment of the present invention. The vibrating pull-up bar 10 is used in a manner similar to conventional pull-up bars, with the primary distinction being that the vibrating pull-up bar 10 imparts a vibrational force on the user, which is transferred throughout the user's body to achieve a full body workout. In this regard, the vibrating pull-up bar 10 not only works out the muscle groups required to achieve the pull up, but also muscle groups throughout the body which are targeted by the vibrational force. In this regard, the vibrating pull-up bar 10 provides a more efficient workout because it targets a larger group of muscles than a conventional pull-up bar.

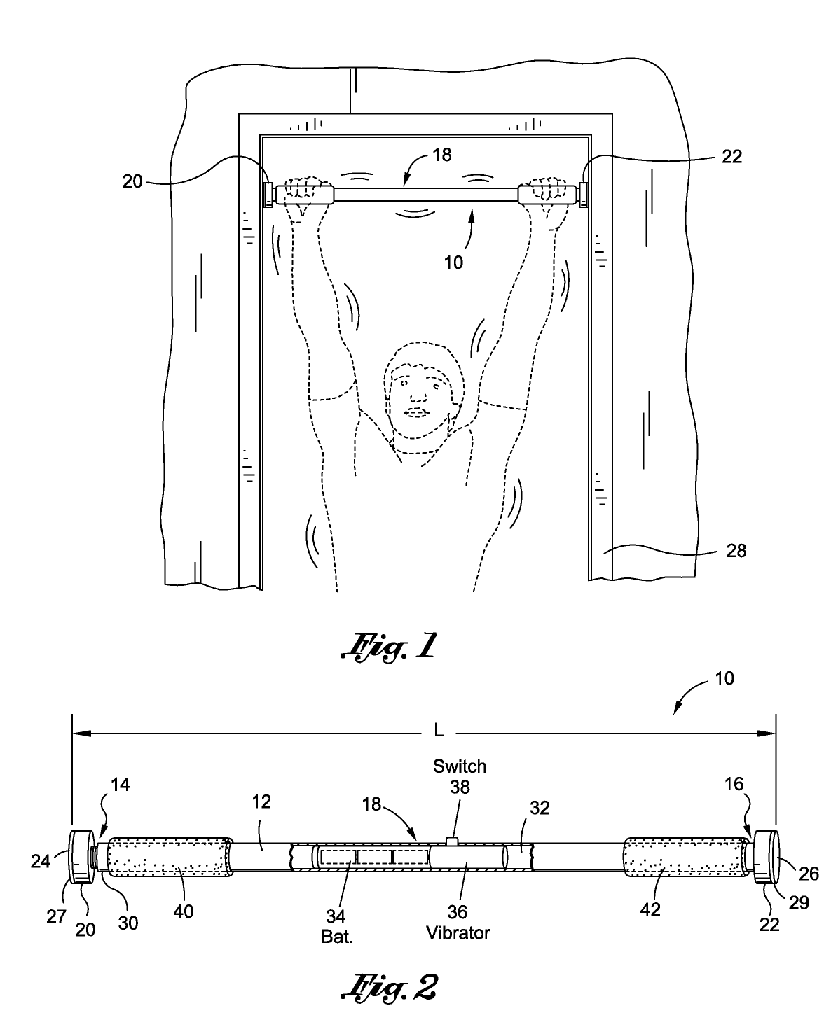

The vibrating pull-up bar 10 includes a bar body 12 defining a first end portion 14, an opposing second end portion 16, and a middle portion 18 disposed between the first end portion 14 and the second end portion 16. The pull up bar 10 additionally includes a pair of adjustable engagement elements 20, 22 connected to the first end portion 14 and the second end portion 16, respectively. Each engagement element 20, 22 defines an engagement surface 24, 26 to define a length “L” therebetween. Each engagement element 20, 22 may be independently and selectively adjusted relative to the bar body 12 to lengthen or shorten the length L to fit the pull-up bar 10 within a door frame 28, as is shown in FIG. 1. Thus, the adjustable nature of the pull-up bar 10 allows the pull-up bar 10 to be used in door frames 28 or other openings or support structures which may vary in size.

According to one embodiment, the first end portion 14 defines a first edge 30 and the bar body 12 includes an inner opening extending into the bar body 12 from the first edge 30. The inner surface of the bar body 12 may be internally threaded at the first end portion 14 to engage with an externally threaded stem of the engagement element 20. Thus, by rotating the engagement element 20, the engagement surface 24 may be moved away from or closer to the first edge 30. The second end portion 16 may be similarly configured, and may define a second edge from which an internal opening extends into the bar body 12, with internal threads disposed along the inner surface of the bar body 12 at the second end portion 16. Furthermore, the engagement element 22 may include an externally threaded stem which is cooperatively engageable with the internally threaded surface of the bar body 12 at the second end portion 16. Therefore, by rotating the engagement element 22, the engagement surface 26 may be moved relative to the second edge. The cooperative engagement between the externally threaded stems of the engagement elements 20, 22 and the internal surface bar body 12 allows for incremental adjustment of each engagement element 20, 22. Although the foregoing describes selective adjustment of the engagement elements 20, 22 via rotation of the engagement elements 20, 22 relative to the bar body 12, it is contemplated that other means of adjustment may be used without departing from the spirit and scope of the present invention. For instance, one embodiment of the pull-up bar 10 may include a spring disposed between the bar body 12 and a respective one of the engagement elements 20, 22 to bias the respective engagement element 20, 22 toward a maximum extended position. Therefore, to fit the pull-up bar 10 within the door frame 28, the user would push each engagement element 20, 22 inwardly until the pull-bar 10 was in proper position within the door frame 28. At that time, the user would release the engagement elements 20, 22, and the springs would urge each engagement element 20, 22 into engagement with the door frame 28.

As shown in FIG. 2, the bar body 12 may define a tubular configuration, and thereby includes an internal opening 32 at the middle portion 18 of the bar body 12. The internal opening 32 may be sized and configured to receive an internal power source 34 and a vibrating element 36. The vibrating element 36 may be configured to generate a vibrational force, and may be sized and configured to impart the vibrating force onto the bar body 12. In this regard, the vibrating element 36 may be complimentary in shape to the internal opening 32 to be disposed in contact therewith. According to one embodiment, the vibrating element 36 includes an internal rotating element having a center of mass which is offset from its rotation axis. Therefore, as the rotating element rotates, the center of mass moves about the rotation axis to generate the vibrational force.

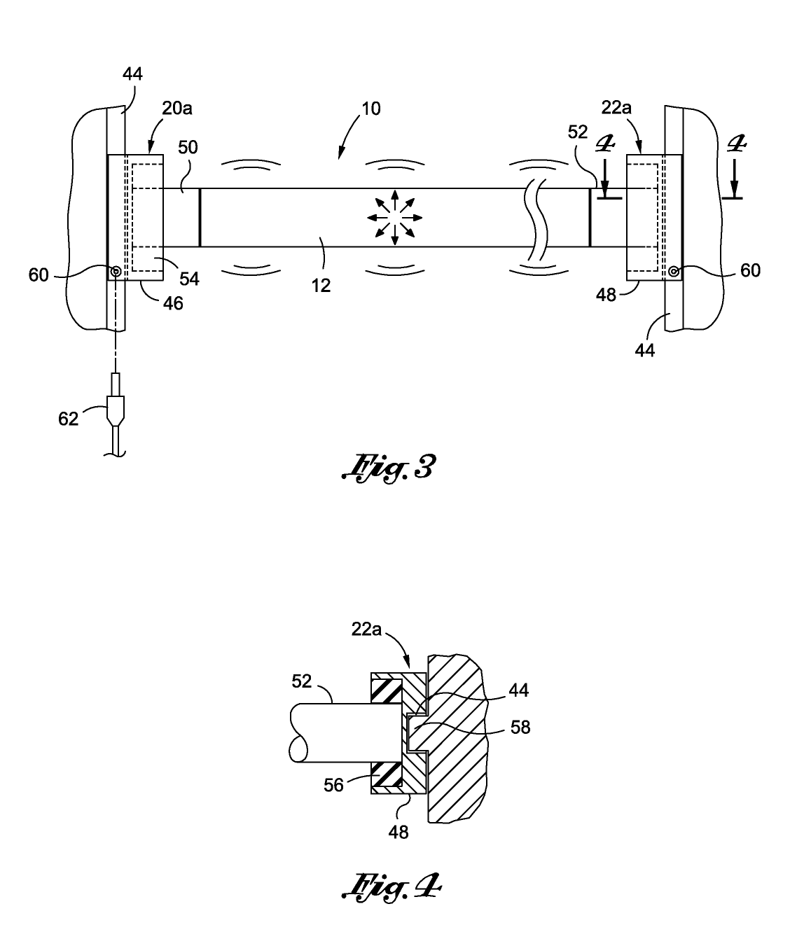

Referring now specifically to FIG. 3, it is contemplated that the vibrating element 36 may cause vibration of the bar body 12 along a plurality of axes. In this regard, the multi-directional nature of the vibration enhances the workout of the individual utilizing the exercise bar 10.

The vibrating element 36 may include a switch 38 which is disposed in operative communication with the internal rotating element to control the rotation thereof. In this regard, the switch 38 may be a simple ON/OFF switch, or the switch 38 may be capable of also varying the rotational speed of the rotating element to thereby alter the vibration frequency. For instance, the vibrating element 36 may be preprogrammed to operate at 3 vibration speeds, i.e., low, medium and high. The switch 38 may be pressed/actuated to change the vibrational speed between the preset modes, as well as an off mode. The vibrating element 36 and the switch 38 may also be configured to allow for incremental adjustment of the vibration frequency generated by the vibrating element 36. For instance, the switch 38 may include a dial which may be rotated to selectively and incrementally increase or decrease the vibration frequency of the vibrating element 36. The switch 38 may also be configured to allow a user to selectively control the direction of the vibration. In this regard, by actuating the switch 38, a user may be able to restrict movement of the vibrating element 36 along a single axis, or alternatively, may be able to cause the vibrating element 36 to vibrate along a plurality of axes.

The vibrating element 36 may be configured to be removeable from the bar body 12. Along these lines, the engagement elements 20, 22 may be disconnected from bar body 12 to provide access to the opening 32 to allow the vibrating element 36 to be removed from the bar body 12. It may be desirable to remove the vibrating element 36 for purposes of replacing the vibrating element 36 with another vibrating element 36 having a rotating element which generates a vibrational force that is different in magnitude than the original vibrating element 36. In this regard, the rotating element of the vibrating element 36 may differ to vary the magnitude of the vibrating force generated by the vibrating element 36. In particular, a heavier rotating element will typically generate a larger vibrating force than a rotating element that is lighter.

Although the foregoing describes a vibrating element 36 that includes an internal rotating element which generates the vibrational force, those skilled in the art will appreciate that other vibration generation elements may be used without departing from the spirit and scope of the present invention. For instance, the vibrating element 36 may include an internal element which translates along an axis in two opposing directions to generate the vibrational force. Furthermore, those skilled in the art will appreciate that more than one vibrating element 36 may be used to generate the vibrational forces.

The pull-up bar 10 additionally includes a pair of gripping members 40, 42 disposed on the outer surface of the bar body 12 adjacent the first end portion 14 and the second end portion 16. According to one embodiment, the bar body 12 defines a diameter less than 5 inches, with the gripping members 40, 42 defining an inner diameter that engages with the outer diameter of the bar body 12. The gripping members 40, 42 may be padded to allow the user to comfortably grip the pull-up bar 10. Furthermore, the gripping members 40, 42 may be formed from a material which allows the user to easily grip the pull up bar. For instance, the gripping members 40, 42 may be formed from a foam material configured to absorb sweat or moisture which may otherwise cause the user to lose his grip.

The gripping members 40, 42 may be configured to be moveable along the length of the bar body 12 to modify the user's workout. For instance, disposing the gripping members 40, 42 toward the lateral ends of the bar body 12 will cause the user to use a wider grip than if the gripping members 40, 42 are positioned in a more medial location along the bar body 12. Furthermore, placing the gripping members 40, 42 closer to the vibrating element 36 may increase the vibrational force imparted on the user.

The pull-up bar 10 includes an internal power source 34 disposed in operative communication with the vibrating element 36. According to one embodiment, the internal power source includes one or more batteries which deliver power to the vibrating element 36. Along these lines, the vibrating element 36 may include electrical contacts which are disposed in electrical communication with the batteries to transfer the power from the batteries to the vibrating element 36, similar to the battery arrangement within a conventional flashlight.

Although the foregoing describes a vibrating element 36 which is disposed internal to the bar body 12, it is contemplated that other embodiments of the pull-up bar 10 may include a vibrating element 36 that is disposed external to the bar body 12. In this regard, the vibrating element 36 may include a collar or sleeve which is secured to the outer surface of the bar body 12 to impart a vibrational force thereto. The collar or sleeve may circumnavigate the bar body 12 and may define an internal annular channel within which an internal element may rotate about the bar body 12. The collar or sleeve type vibrating element may include its own power source, i.e., batteries disposed therein, or it may include an electrical contact which may interface with an electrical contact on the outer surface of the bar body 12 to transfer power from an internal power source 34 to the external rotating element.

The bar body 12 is preferably formed from a flexible material which is capable of enduring the vibrations caused by the vibration element 36, while at the same time being strong enough to support a user performing a pull up. Materials such as rubbers, plastics, and other materials in the art may be used to form the bar body 12. In another embodiment, the bar body 12 may be configured to move relative to the engagement elements 20, 22 as the bar body 12 vibrates. In this regard, springs may be disposed within the bar body 12 in the engagement elements 20, 22 to allow for movement between the bar body 12 and the engagement elements 20, 22.

Each engagement element 20, 22 may include a padded portion 27, 29 which defines the engagement surfaces 24, 26 to mitigate damage to the door frame 28 when the pull up bar 10 is connected to the door frame 28.

Referring now specifically to FIGS. 3 and 4, there is shown another embodiment of engagement elements 20a, 22a, which may be used with the bar body 12. The engagement elements 20a, 22a are designed to allow enhanced movement of the body bar 12 relative to the engagement elements 20a, 22a. Furthermore, the engagement elements 20a, 22a are additionally configured to engage with a strip 44 on the door frame 28 to lock the engagement elements 20a, 22a in place relative to the door frame 28.

Each engagement element 20a, 22a, includes a respective end cap portion 46, 48, and a stem portion 50, 52, wherein the stem portion 50, 52 is moveable relative to the respective end cap portion 46, 48. The end cap portion 46, 48 includes a cavity 54, 56 within which the respective stem portion 50, 52 may move. Various bearings, springs or other similar mechanical elements which allow for movement of the stem portions 50, 52 relative to the end cap portions 46, 48.

The stem portions 50, 52 may further be configured to engage with the bar body 12, as described in more detail above.

Each engagement element 20a, 22a is configured to include a channel 58 designed to engage with the strip 44 on the door frame 28. In this regard, the channel 58 may define a shape that is substantially complimentary to the shape of the strip 44, such that the engagement element 20a, 22a frictionally engages with the strip 44 to lock the engagement element 20a, 22a in place, i.e., to prevent rotation of the engagement element 20a, 22a, relative to the strip 44.

The engagement elements 20a, 22a, may include an auxiliary power port 60 in operative communication with the vibration element 36 to provide power to the vibration element 36. The auxiliary power port 60 may be connectable with a power chord 62, which in turn, is connectable to a power outlet on a wall to receive power therefrom.

Additional modifications and improvements of the present invention may also be apparent to those of ordinary skill in the art. Thus, the particular combination of components and steps described and illustrated herein is intended to represent only certain embodiments of the present invention, and is not intended to serve as limitations of alternative devices and methods within the spirit and scope of the invention.

What is claimed is:

1. A grippable, vibrating exercise bar for use by a user to perform an exercise, the vibrating exercise bar comprising:
an elongate body having opposed first and second end portions, the elongate body defining a tubular configuration having an inner compartment, the elongate body being sized and configured to be hand grippable to support a user gripping the elongate body; and
a vibrating element disposed within the inner compartment and configured to vibrate relative to the elongate body;
the elongate body being configured to vibrate in response to vibration of the vibrating element to impart a vibratory force to the user gripping the elongate body.

2. The exercise bar as recited in claim 1, further comprising a power source in operative communication with the vibrating element to provide power to the vibrating element.

3. The exercise bar as recited in claim 2, wherein the power source is disposed within the inner compartment.

4. The exercise bar as recited in claim 1, wherein the elongate body defines a generally cylindrical configuration.

5. The exercise bar as recited in claim 1, wherein the elongate body defines an outer diameter less than or equal to 5 inches.

6. The exercise bar as recited in claim 1, wherein the vibrating element is configured to vibrate along at least two axes.

7. The exercise bar as recited in claim 1, wherein the vibrating element vibrates at a vibrating frequency, the vibrating frequency being selectively adjustable.

8. The exercise bar as recited in claim 1, further comprising a pair of engagement pads, each engagement pad being connected to the elongate bar at respective ones of the first and second end portions.

9. The exercise bar as recited in claim 8, wherein:
each engagement pad extends away from the elongate body and terminates at a distal end;
the elongate body and the engagement pads being configured to allow for selective adjustment of the distance between the distal ends.

10. The exercise bar as recited in claim 9, wherein the adjustment of the distance between the distal ends is effectuated by rotation of the elongate body relative to at least one engagement pad.

11. The exercise bar as recited in claim 9, wherein each engagement pad includes a middle channel extending into the engagement pad from the respective distal end.

12. The exercise bar as recited in claim 8, wherein each engagement pad is formed from a resilient material.

13. A vibrating pull-up bar configured for use in a door frame to allow a user to perform an exercise, the vibrating pull-up bar comprising:
an elongate body having opposed first and second end portions, the elongate body defining a tubular configuration having an inner compartment, the elongate body being sized and configured to be hand grippable to support a user gripping the elongate body;
a pair of engagement elements coupled to the elongated body at respective ones of the first and second end portions thereof, the pair of engagement elements being engageable with the door frame to couple the elongate body to the door frame; and
a vibrating element disposed within the inner compartment and configured to vibrate relative to the elongate body;
the elongate body being configured to vibrate in response to vibration of the vibrating element to impart a vibratory force to the user gripping the elongate body.

14. The exercise bar as recited in claim 13, further comprising a power source in operative communication with the vibrating element to provide power to the vibrating element.

15. The exercise bar as recited in claim 13, wherein the elongate body defines an outer diameter less than or equal to 5 inches.

16. The exercise bar as recited in claim 13, wherein the vibrating element is configured to vibrate along at least two axes.

17. The exercise bar as recited in claim 13, wherein the vibrating element vibrates at a vibrating frequency, the vibrating frequency being selectively adjustable.

18. The exercise bar as recited in claim 13, wherein:
each engagement element extends away from the elongate body and terminates at a distal end;
the elongate body and the engagement elements being configured to allow for selective adjustment of the distance between the distal ends.

19. The exercise bar as recited in claim 18, wherein the adjustment of the distance between the distal ends is effectuated by rotation of the elongate body relative to at least one engagement pad.

20. The exercise bar as recited in claim 18, wherein each engagement element includes a middle channel extending into the engagement element from the respective distal end.
